(19) United States
(12) Patent Application Publication
(10) Pub. No.: US 2007/0063971 A1
(43) Pub. Date: Mar. 22, 2007

(54) Actuator for an elongated object for a force feedback generating device

(75) Inventors: Ivan Vecerina, Lausanne (CH); Stephane Betrisey, Morges (CH); Jurjen Zoethout, Payerne (CH)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: XITACT S.A.

(21) Appl. No.: 11/518,915

(22) Filed: Sep. 12, 2006

Related U.S. Application Data
(63) Continuation of application No. PCT/EP05/51032, filed on Mar. 8, 2005.

(30) Foreign Application Priority Data
Mar. 12, 2004 (EP) 04405148.0

(51) Int. Cl. G09G 5/00

(52) U.S. Cl. 345/156

(57) ABSTRACT

An actuator for an elongated object may include one or two electromagnetically-activated braking mechanisms to provide haptic sensations in conjunction with a device that tracks a rotationally symmetric instrument manipulated by a user. A contact-free motion sensor may provide information about the longitudinal movement and about the rotational movement of the instrument, and a control unit may receive movement information from the motion sensor and may be connected with the electromagnetically-activated braking mechanisms. Each braking mechanism may include a first surface and a second surface, the second one at least being movable in the direction of the first one to pinch or release the instrument as a function of the motion information provided by the motion sensor. In the case of two braking mechanisms a braking force may be applied on the guided instrument for both degrees of freedom independently.

This application is a continuation under 35 U.S.C. § 120 of prior International Application No. PCT/EP2005/051032, filed on Mar. 8, 2005 and claiming priority to European (EP) Patent Application No. 04405148.0, filed Mar. 12, 2004.

### TECHNICAL FIELD

The present disclosure relates to devices that provide tactile sensations to a user manipulating elongated instruments. In particular, the disclosure relates to devices that can be used to provide realistic haptic sensations in simulations of medical interventions where, for example, catheters or other instruments are inserted through an entry port to interact with a virtual environment. Such devices can be useful, as well to provide enhanced tactile sensations, during a real procedure to help guide the gestures of a surgeon or interventionist—for enhanced reality and computer-assisted interventions. The simulations can be used to train the performance of minimally invasive interventions, such as percutaneous procedures, where instruments are inserted through the skin into the patient body, under various kinds of guidance or visualization, including, for example: X-ray (most common), ultrasound, or other means of visualizing or identifying the position of the instruments.

### BACKGROUND INFORMATION

Haptic sensations can provide essential information to the therapist performing a percutaneous procedure. Various types of forces or resistances opposing the motion of instruments can be encountered. Among many possible examples: the tip of the instrument may hit an obstacle that prevents further motion; while advancing along a vessel, the traversal of a narrowing or tortuosity can generate an increased resistance; a “pop” (brief drop in resistance) may be felt as the tip of a catheter enters a branch of a vessel; the tip of the instrument may skip over irregularities of a cavity's wall; and the elastic bending or unfolding of a catheter may also generate an elastic directional force felt by the interventionist.

Real medical catheters may be designed to precisely transmit forces and motion between the tip of the instrument and the hand of a physician, allowing him to feel the structures that are being encountered or manipulated. During simulated procedures in particular, it may be important to reproduce these haptic sensations as reliably as possible. During actual procedures, a similar actuator can be used to enhance the tactile sensations perceived by an interventionist—for example to impede access to a dangerous area.

Convention solutions include force feedback devices that involve the motion and inertia of relatively heavy parts and motors—which may interfere with the free motion of the catheter and with the precise reproduction of forces.

For example, the device proposed in European (EP) Patent Document No. EP 0 970 714 A2 includes a carriage assembly holding a catheter between a pair of opposed pinch wheels. This carriage assembly rotates to rotate the catheter about its longitudinal axis, and the pinch wheels rotate to translate the object axially. The inertia of this mechanism, however, interferes with the free motion of the catheter in a perceptible fashion. Furthermore, driving the motion of the pinch wheels mounted on the rotating carriage assembly is problematic.

In U.S. Pat. No. 6,267,599, a framed assembly is disclosed that is mounted on parallel guide rails, with rotation sensors mounted on the framed assembly. A motorized system ensures that this assembly follows the motion of the tip of an inserted instrument. Servomotors and force sensors attempt to compensate for the friction and inertia of the system, while providing force feedback to the user.

Because these systems rely on several parts that are in continuous contact with the inserted instrument, they all suffer from the fact that these actuating devices, in idle state, generate inertia and friction forces that may be perceptible to a user manipulating the system.

The need remains, therefore, for a device that can generate haptic force-feedback on elongated instruments without interfering with the free motion of these instruments when no forces are to be generated.

The present disclosure is the result of a different approach, which takes advantage of contact-free or low-friction tracking mechanisms, such as that for which Applicants have filed a patent application as disclosed in, European (EP) Patent Document No. EP 1 517 119 A1 (related to U.S. Patent Publication No. 2005/0075558 A1, filed on Sep. 22, 2004), the contents of which is incorporated herein by reference.

### SUMMARY OF THE INVENTION

The present disclosure relates on the insight that an actuating device that only engages with the instrument when a force needs to be generated can improve the quality of the generated haptic sensations, and increase the overall realism of a simulation. During a real procedure as well, it may allow a constraint-free manipulation of the instruments until forces actually are to be generated.

Furthermore, an actuating device including a simple brake that engages with the instrument is in many cases sufficient to generate the desired haptic sensations—as long the braking force is controlled precisely, and in a fashion where it is dependent on the motion of the instrument. Such a mechanism may be especially effective when a friction-like resistance to motion is a continuous component of the forces that need to be generated. For example, the user can be given the perception that an active elastic force is being applied by reducing, or suppressing, the braking force when the instrument is moved in a direction that follows the active elastic force, and by increasing the resistance when the instrument is pushed against the active force. However, an optimum response time and a sensitivity to small displacement may be required for a proper rendering of haptic sensations.

The present disclosure indicates how a braking system can be used in conjunction with a contact-free motion-tracking device to reproduce a variety of haptic sensations on an inserted instrument, and describes specific embodiments of this system. It explains how a processor can use a description of pre-computed forces (provided for example by a simulation model) to instantly control actuators based on motion information. Also, it presents enhancements that can be used to apply a braking force on one degree of freedom only, or to engage an active force-feedback mechanism able to generate active forces that may control the motion of an inserted instrument.

### BRIEF DESCRIPTION OF THE DRAWINGS

FIG. 1 shows an overview of an exemplary force feedback device including a braking system used in combination with an instrument tracking device.

FIG. 2 shows an embodiment of an actuator of the braking system or engaging mechanism.

FIG. 3 shows a graph, illustrating a manner in which the braking system may let the user perceive the effect of an active directional force by altering the braking force according to the motion of the instrument.

FIG. 4 shows another embodiment of the device of FIG. 2 which can be used to soften the perceived change in forces when the motion direction is changed.

FIG. 5 shows other embodiments of the device in FIG. 1, which are able to individually constrain the motion of the instrument along a specific axis of motion.

FIG. 6 shows an active actuating system combined with an engaging mechanism to allow free motion of the instrument when no force is being applied.

FIG. 7 shows an embodiment of a contact-free motion sensor, according to an aspect of the disclosure.

### DETAILED DESCRIPTION

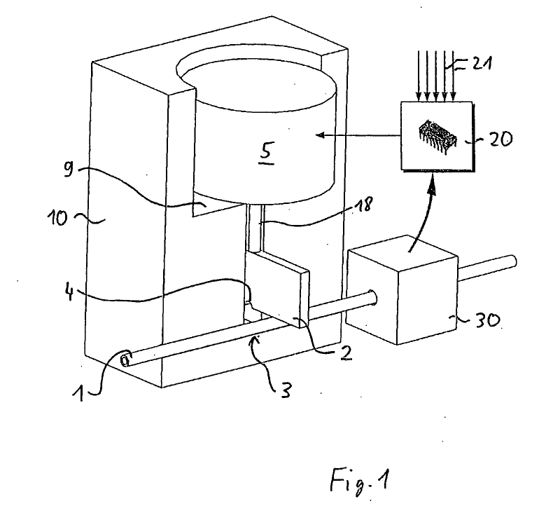

FIG. 1 shows an overview of an electromagnetic braking system that can be applied to catheters and other elongated instruments or apparatuses 1. Instrument 1 may include a catheter or other apparatus that is inserted through the device, which may be manipulated by a user. The system may be associated with a contact-free motion sensor 30 that measures the motion of the instrument 1 that traverses both elements. Motion sensor 30 may provide information about the longitudinal movement and about the rotational movement of instrument 1.

A processor 20, which may include a simple electronic circuit, may continuously receive, from the tracking device 30, information about the longitudinal and rotational motion of instrument 1. Based on a motion axis and orientation signal received from tracking device 30, processor 20 may select one of several braking forces computed by an external source (shown as arrows 21 in FIG. 1). The external source can be a computer or PC running a virtual simulation of an environment with which instrument 1 may interact, or any model used to define forces to be applied.

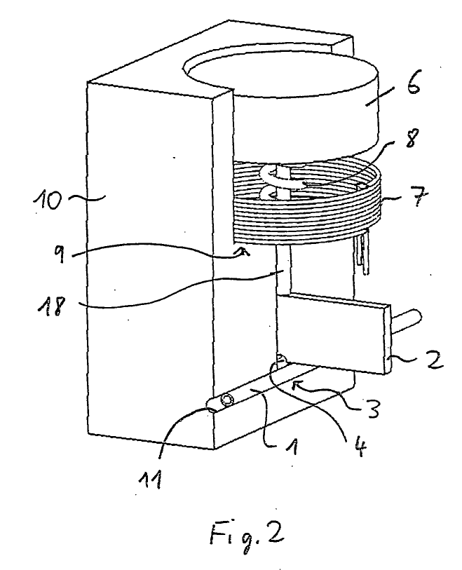

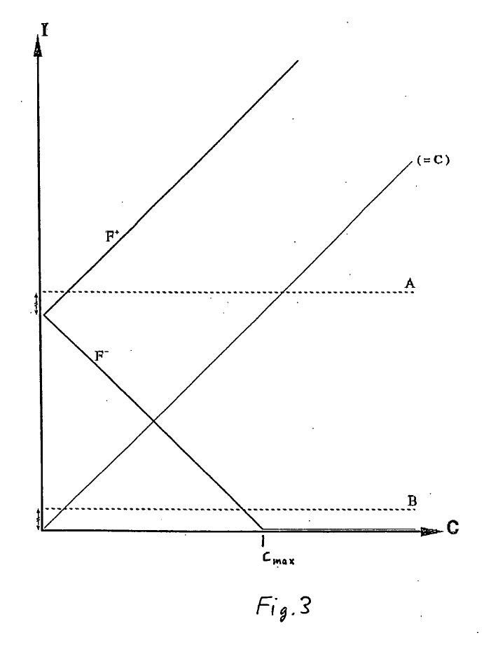

Instrument 1 may pass between a pressing clip 2 and a wall or counter-surface 3. Pressing clip 2 may comprise a recess 4 complementary to the form of instrument 1. Pressing clip 2 may be attached to an actuator 5. Actuator 5 can be a hydraulic piston or even a stepper motor. In a preferred embodiment, actuator 5 is an electromagnetic actuator, such as the one described in FIG. 2.

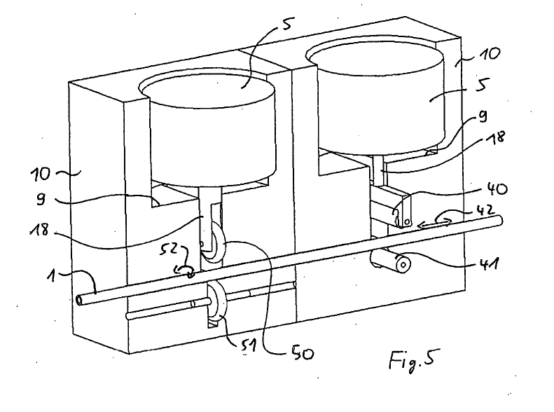

The selected braking force signal is transmitted to linear actuator 5, which may press a braking system (pressing clip) 2 against instrument 1, pinching it against wall 3 of a cavity it traverses, thereby creating a resistance to its motion. Using a system of levers (see FIG. 5 for a possible embodiment), counter-surface 3 may also be moved against instrument 1 and engaged only when needed.

FIG. 2 presents an embodiment of linear force actuator 5, based on an electromagnetic actuation system. The force signal is an electrical current applied to a coil 7, which may act as an electromagnet. When activated, the electromagnet may attract a permanent magnet 6. This attraction force may be transmitted through shaft 18 to braking system 2, which may pinch instrument 1 and create a resistance to its motion. A spring-loaded mechanism 8 may ensure that, when electromagnet 7 is idle, brake 2 may be dissociated from instrument 1. Spring 8 may push against an abutment surface 9 within a body 10 of the device and against magnetic mass 6, which can be a permanent magnet. As a current is applied through coil 7, a magnetic field may be generated that may push pressing clip 2 against instrument 1, which may thereby be pinched against counter-surface 3. Counter-surface 3 may be, in the embodiment shown, part of bottom surface 11 of the guiding hollow room of instrument 1.

By adjusting the current going through coil 7, using, for example, pulse width modulation or voltage control, the pressure of brake 2 onto instrument 1 can be controlled accurately and with excellent response times of well under 1 millisecond.

Tracking device 30 may preferably include a high-resolution contact-free sensor sensitive to a minute motion of instrument 1 like, for example, the optical tracking device disclosed in the above-mentioned European (EP) Patent Document No. EP 1 517 119 A1, the content of which is incorporated herein by reference.

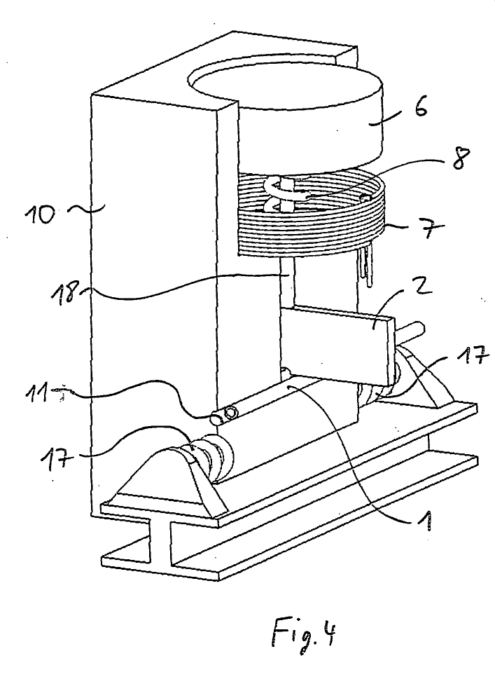

More precisely, as shown in FIG. 4, the contact-free motion sensor may include an optical navigation sensor 64 comprising at least one light source 31 and at least one image capturing transducer 32, wherein light emitted by light source 31 may be directed onto an inner or an outer surface of rotationally symmetrical apparatus 1. The light reflected from the inner surface or the outer surface may then be detected by image capturing transducer 32 to produce a position signal showing a locally varying distribution in the longitudinal direction and in the rotational direction to enable a relative position and angular measurement. Optical navigation sensor 64 may then be used to compute the longitudinal and rotational motion of apparatus 1.

Consistent with the present disclosure, braking system 2 may be used in combination with a high-resolution friction-free instrument-tracking unit 30. At a control rate that is preferably of several kilohertz, processor 20 may receive motion information from tracking unit 30, and may immediately adapt the pressure of brake 2 based on the motion of instrument 1 according to pre-computed forces 21. For example, the processor may pre-compute forces for each direction of the instrument motion that can be reported by tracking unit 30, and eventually for various amplitudes of motion, and ranges of total displacements of instrument 1.

In one embodiment, braking device 2 may be used to generate a continuous friction force, creating a resistance to the motion of instrument 1. When this is the case, an active (or elastic) directional force can be simulated by reducing the braking force applied on instrument 1 when instrument 1 is moved in the same direction as the active force, and increasing it when instrument 1 is moved in an opposite direction.

FIG. 3 illustrates, along one axis of motion, how the desired braking force (F+, F−) can be computed by combining, according to the direction of the instrument's motion, a passive friction force A and an active directional force C that need to be produced. When applying a braking force to simulate a friction force A, an estimate of the friction level intrinsic to the device is subtracted first. Given a certain friction force level to be produced A, the intrinsic friction in the tracking system B, and the directional force to be produced C, the braking force is computed for each direction of motion.

The force F+ to be applied when instrument 1 moves in a direction opposite to the active force C is computed using the following equation: F+=(A−C)+B.

The force F− to be applied when instrument 1 moves in the direction of the active force C is computed using: F−=(A−C)−B. However, this resulting braking force may not have a negative value. This implies that the maximum active force that can be simulated, Cₘₐₓ, may be the difference between the friction force to be simulated at a given point in time and the intrinsic friction of the device.

Because a small motion of instrument 1 may be required to detect a change in the motion direction or force applied to instrument 1, the user may need to initially overcome the friction currently applied to instrument 1. This issue may be mitigated by using high-resolution tracking device 30, so a small displacement that is allowed by the elasticity or play of the braking component is sufficient to detect a change in the direction of the motion. Braking device 2 can be assembled as to ensure that a small-range of free motion is allowed by the braking system.

FIG. 4 illustrates an exemplary assembly, where braking device 2 may be kept in place by springs 17, allowing it to follow the motion of instrument 1 on a small longitudinal distance before the effect of brake 2 can be perceived. This may be true in the range where the spring force of springs 17 is smaller then the braking force applied by braking plate 2. This system can be used to compensate for an insufficiently sensitive tracking system 30, or to increase the perceived “elasticity” of the force feedback system.

The principle described in FIG. 4 can be applied to two or more axes of motion. When a single brake uniformly affects all motion axes, the braking force can either be determined based on the predominant direction of motion, or by using various forms of interpolation between the forces pre-computed for each component of the motion vector.

Forces may be pre-computed not only for multiple motion directions, but also for multiple relative positions of instrument 1. Processor 20 can then react to the current motion direction and to the total displacement reported by tracking unit 30 since the forces were computed.

The computations described above can be used to compute force signal on the input of processor 20, which will select the actuating force F+ or F− based on the direction of the instrument's motion along one axis of freedom. Such a computation can be performed for each axis of motion of instrument 1 inside tracking device 30. However, because actuator 5 described in FIGS. 1 and 2 may affect both the longitudinal and rotational motion of instrument 1, processor 20 may have to select a dominant axis of motion based on the motion information received from sensor 30. Alternatively, it might use some form of interpolation or combination between input forces specified along each axis of motion. Yet another approach to address this issue is disclosed in FIG. 5.

When motion occurs simultaneously along multiple axes, it is sometimes desirable to independently brake on one axis of motion while allowing free motion along an orthogonal axis—for example when the instrument tip hits a perpendicular wall. A modification of the previously described braking system can allow such an independent braking of a single axis of motion.

Two embodiments of a directional braking system are illustrated in FIG. 5 including, for example, a wheel 50 or rolling barrel 40 added to the braking component, to allow a low-friction motion of instrument 1 in the direction of the wheel's motion. In the left part of FIG. 5, braking component 50 may pinch instrument 1 between two wheels 50 and 51 whose axes are parallel to the axis of instrument 1. Wheels 50, 51 allow a low friction rotational motion (arrow 52) of instrument 1, and will primarily interfere with the longitudinal motion (arrow 42) of instrument 1. Inversely, braking device 40, which pinches instrument 1 between parallel rollers 40 and 41, whose axes are orthogonal to the axis of instrument 1, allow the low friction longitudinal motion (arrow 42) of instrument 1, and will primarily interfere with a rotational motion (arrow 52) of instrument 1.

Using the principles illustrated above in FIGS. 1, 3, and 5, the two resulting forces computed along each axis of motion (as per FIG. 3) can be transmitted to independent processors dedicated to each axis of motion (as per FIG. 1) and transmitted to independent actuators 50 and 40 (as illustrated in FIG. 5).

Alternatively, either of the braking devices in FIG. 5 can be combined with the device illustrated in FIG. 1, which may be less complex to manufacture. The preferred simple combination of brakes is the use of the device on the left side of FIG. 5, still allowing the low friction rotation of instrument 1 but braking the longitudinal motion together with the more simpler device according to FIG. 1, which may be adapted to brake both movements (longitudinal and rotational). The unit shown on the left side of FIG. 5 then can apply an increased braking force to the longitudinal movement only. This may be useful to simulate the resistance perceived when the instrument tip hits a perpendicular obstacle, and the rotation and advancement of instrument 1 are attempted simultaneously.

In any case, a calibration of the effective resistance to motion applied by each braking device along each axis of motion may be desirable. Processors of each braking unit may exchange force signals and adjust the output force to optimize the end result.

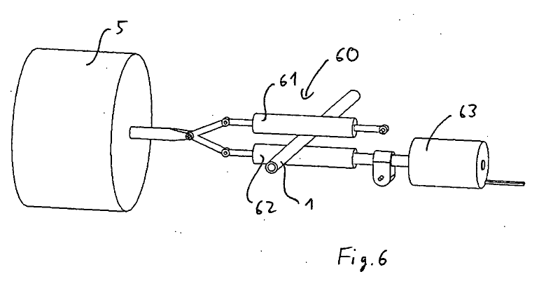

Another embodiment related to the present disclosure is illustrated in FIG. 6. In this figure, a different arrangement including a linear actuator 60 is illustrated. By exercising a traction on the levers, actuator 5 may bring rollers 61 and 62 closer together, engaging the rollers with instrument 1. The motion of at least one of the rollers is controlled by a motor 63.

When no active driving force needs to be applied by motor 63, rollers 61 and 62 may be left disjoint and may not be in contact with instrument 1. When a force needs to be applied using motor 63, to generate haptic force feedback or to actively move instrument 1 longitudinally, actuator 5 may close the gap between rollers 61 and 62 and may engage instrument 1 between them. As a result, this design integrates an active instrument driving mechanism, while simultaneously ensuring that, when the mechanism is idle, no unwanted forces (caused by inertia or friction within the motor) will interfere with the free motion of instrument 1.

When motor 63 is idle or actively kept immobile, linear actuator 60 in FIG. 6 can be used to apply forces following the same principle as the braking system in FIG. 1.

1-11. (canceled)

12. An actuator configured to act on an elongated apparatus when the latter is guided in the actuator by an operator, comprising:
a first braking mechanism configured to operate in response to a braking signal produced by a control unit on the basis of motion information provided by a contact-free motion sensor, the first braking mechanism being configured to provide the operator with haptic sensations on the basis of the apparatus motion; and
wherein the first braking mechanism further comprises a first surface and a second surface, between which the elongated apparatus is guided, the second surface being movable in the direction of the first surface, on the basis of the motion information, to pinch or release the apparatus while the latter is guided in the actuator, and to apply an adjustable pressure force onto the apparatus in case of pinching.

13. An actuator according to claim 12, wherein the first surface is a still counter-surface on which the apparatus slides when guided by the operator.

14. An actuator according to claim 12, wherein the first surface is also movable.

15. An actuator according to claim 12, configured to be used in a simulated or in a real medical procedure, wherein the apparatus includes a rotationally symmetrical shape and is guided in both a longitudinal direction and a rotational direction by the operator; and
wherein the second surface includes a predefined shape substantially matching the apparatus shape.

16. An actuator according to claim 15, wherein the first braking mechanism comprises a support connected to a still structure by an elastic connection, the elastic connection being configured to allow the first braking mechanism to move elastically about a rest position along the longitudinal direction, as pinching is implemented.

17. An actuator according to claim 12, configured to be used in a simulated or in a real medical procedure, wherein the apparatus is rotationally symmetric and is guided in both a longitudinal direction and a rotational direction by the operator;
wherein the first braking mechanism is configured to provide the operator with haptic sensations on the basis of the apparatus motion along the longitudinal direction; and
wherein the actuator further comprises a second braking mechanism, the second braking mechanism being configured to provide the operator with haptic sensations on the basis of the apparatus motion along the rotational direction.

18. An actuator according to claim 17, wherein the first and second surfaces of the first braking mechanism are borne by respective rotationally symmetrical elements rotating about respective axes that are both substantially perpendicular to the longitudinal direction; and
wherein the second braking mechanism includes first and second surfaces borne by respective rotationally symmetrical elements rotating about respective axes that are both substantially parallel to the longitudinal direction.

19. An actuator according to claim 18, further comprising a driving assembly configured to drive in rotation at least one of the rotationally symmetrical elements on the basis of the motion information.

20. An actuator according to claim 12, wherein the first and second braking mechanisms comprise an electromagnetic linear actuator to control the movement of the second surface.

21. An actuating assembly including an actuator for acting on an elongated apparatus when the latter is guided in the actuating assembly by an operator, the actuator assembly further comprising:
a contact-free motion sensor adapted to provide motion information to a control unit on the basis of motion of the apparatus; and
a first braking mechanism configured to provide the operator with haptic sensations on the basis of motion of the apparatus, the first braking mechanism being distinct from the contact-free motion sensor and arranged to be operated in response to a braking signal produced by the control unit on the basis of the motion information;
wherein the first braking mechanism comprises at least a first surface and a second surface, between which the elongated apparatus is guided, the second surface being movable in the direction of the first surface on the basis of the motion information, to pinch or release the apparatus, and to apply an adjustable pressure force onto the apparatus in case of pinching.

22. An actuating assembly according to claim 21, configured to be used in a simulated or in a real medical procedure, wherein the apparatus is rotationally symmetric and is guided in both a longitudinal direction and a rotational direction by the operator;
wherein the first braking mechanism is configured to provide the operator with haptic sensations on the basis of the apparatus motion along the longitudinal direction; and
wherein the actuator further comprises a second braking mechanism, the second braking mechanism being configured to provide the operator with haptic sensations predominantly on the basis of the apparatus motion along the rotational direction.

23. An actuator according to claim 13, configured to be used in a simulated or in a real medical procedure, wherein the apparatus includes a rotationally symmetrical shape and is guided in both a longitudinal direction and a rotational direction by the operator; and
wherein the second surface includes a predefined shape substantially matching the apparatus shape.

24. An actuator according to claim 14, configured to be used in a simulated or in a real medical procedure, wherein the apparatus includes a rotationally symmetrical shape and is guided in both a longitudinal direction and a rotational direction by the operator; and
wherein the second surface includes a predefined shape substantially matching the apparatus shape.

25. The actuator according to claim 23, wherein the first braking mechanism comprises a support connected to a still structure by an elastic connection, the elastic connection being configured to enable the first braking mechanism to move elastically, about a rest position along the longitudinal direction, as pinching is implemented.

26. The actuator according to claim 24, wherein the first braking mechanism comprises a support connected to a still structure by an elastic connection, the elastic connection being configured to enable the first braking mechanism to move elastically, about a rest position along said longitudinal direction, as pinching is implemented.

27. The actuator according to claim 13, wherein the first braking mechanism comprises an electromagnetic linear actuator to control the movement of the second surface.

28. The actuator according to claim 14, wherein the first braking mechanism comprises an electromagnetic linear actuator to control the movement of the second surface.

29. The actuator according to claim 17, wherein each braking mechanism comprises an electromagnetic linear actuator to control the movement of the second surface.

30. The actuator according to claim 18, wherein each braking mechanism comprises an electromagnetic linear actuator to control the movement of the second surface.

31. The actuator according to claim 12, wherein the contact-free motion sensor includes an optical navigation sensor comprising:
at least one light source; and
at least one image capturing transducer;
wherein light emitted by the light source is directed onto an outer surface of the rotationally symmetrical apparatus or on an inner surface of the longitudinal element; and
wherein reflected light from the inner surface or the outer surface is detected by the image capturing transducer to produce a position signal showing a locally varying distribution in a longitudinal direction and in a rotational direction to enable a relative position and angular measurement.
